(19) United States
(12) Patent Application Publication
(10) Pub. No.: US 2024/0380787 A1
(43) Pub. Date: Nov. 14, 2024

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: JUNJI SATO, Kanagawa (JP)

(21) Appl. No.: 18/643,165

(22) Filed: Apr. 23, 2024

(30) Foreign Application Priority Data
May 8, 2023 (JP) 2023-076840

(51) Int. Cl. H04L 9/40; H04N 1/00

(52) U.S. Cl. CPC H04L 63/20; H04N 1/00244; H04N 1/00344

(57) ABSTRACT

An information processing apparatus is capable of being connected to a monitoring apparatus via a first network, configured for the purpose of transmitting operation information to a management server via a second network and the first network in accordance with monitoring by the monitoring apparatus. The information processing apparatus receives, from the monitoring apparatus, registration information for the management server that includes information indicating an environment type of the first network to which the information processing apparatus can be connected; performs a security setting corresponding to the environment type, based on information indicating the environment type; and performs communication to initiate a connection to the management server based on the registration information.

### BACKGROUND OF THE INVENTION

### Field of the Invention

The present disclosure relates to an information processing technology for a device that may be connected to a network.

### Description of the Related Art

In general, information processing apparatuses that are connected to a network have a setting function to perform settings of security-related functions based on a user operation. In recent years, information processing apparatuses have come to be installed in various environments, such as at home for a teleworking environment or in a public space environment shared by a large number of unspecified persons, and the required security settings have become increasingly complex.

For example, Japanese Patent Application Laid-Open No. 2007-185814 discloses a technology whereby a user specifies one security level from among graded security levels, and the setting of a plurality of setting items of an image forming apparatus is performed by batch in accordance with that security level. Specifically, this image forming apparatus performs the batch setting based on information indicating the relationship between the graded security levels and the setting values of the plurality of setting items.

It is desirable that security functions suitable for an installation environment on the network are set for the image forming apparatus. However, in the technology of Japanese Patent Application Laid-Open No. 2007-185814, it is difficult for the user to determine which security level should be specified for the installation environment of the image forming apparatus.

### SUMMARY OF THE INVENTION

Accordingly, the present disclosure provides a technology that can perform appropriate security settings according to an installation environment of an information processing apparatus on a network.

An information processing apparatus according to an embodiment of the present disclosure is capable of being connected to a monitoring apparatus via a first network, configured in order to transmit operation information to a management server via a second network and the first network in accordance with monitoring by the monitoring apparatus. The information processing apparatus comprises a memory storing instructions, and a processor executing the instructions causing the information processing apparatus to receive, from the monitoring apparatus, registration information for the management server that includes information indicating an environment type of the first network to which the information processing apparatus can be connected, perform a security setting corresponding to the environment type, based on information indicating the environment type, and, perform communication in order to initiate a connection to the management server based on the registration information. Further features of the present invention will become apparent from the following description of exemplary embodiments with reference to the attached drawings.

### BRIEF DESCRIPTION OF THE DRAWINGS

FIG. 1 is a diagram showing a configuration of a management system that includes an image forming apparatus according to a First Embodiment.

FIG. 2 is a diagram showing an example of a hardware configuration of a management server.

FIG. 3 is a diagram showing an example of a hardware configuration of an image forming apparatus.

FIG. 4A is a diagram showing an example of a software configuration of an image forming apparatus, and FIG. 4B is a diagram showing an example of an environment type setting screen displayed on an operation unit.

FIG. 5A is a diagram showing an example of a software configuration of a management server, and FIG. 5B is a diagram showing an example of a software configuration of a monitoring apparatus.

FIG. 6 is a diagram showing an example of group information held by a group information management unit.

FIG. 7A-FIG. 7C are diagrams showing examples of a web application screen of a management server.

FIG. 8 is a diagram showing an example of a group editing screen in a Web application screen.

FIG. 9 is a diagram showing an example of group information received by a monitoring apparatus from a management server.

FIG. 10 is a flowchart showing device registration processing by a monitoring apparatus.

FIG. 11 is a diagram showing an example of device registration information received by an image forming apparatus.

FIG. 12 is a flowchart showing device connection processing executed by an image forming apparatus.

FIG. 13 is a flowchart showing the installation environment setting processing of step S1202 in FIG. 12.

FIG. 14 is a diagram showing an example of a device list screen of a management server.

FIG. 15 is a diagram showing an example of a screen provided by an image forming apparatus in a case in which changes by the user to one or more environment types are restricted.

FIG. 16 is a diagram showing an example of device information notified to a management server.

FIG. 17 is a flowchart showing device information verification processing by a management server.

FIG. 18A and FIG. 18B are diagrams showing examples of Web application screens of a management server.

### DESCRIPTION OF THE EMBODIMENTS

Hereinafter, with reference to the accompanying drawings, favorable modes of the present invention will be described using Embodiments. In each diagram, the same reference signs are applied to the same members or elements, and duplicate description will be omitted or simplified.

### First Embodiment

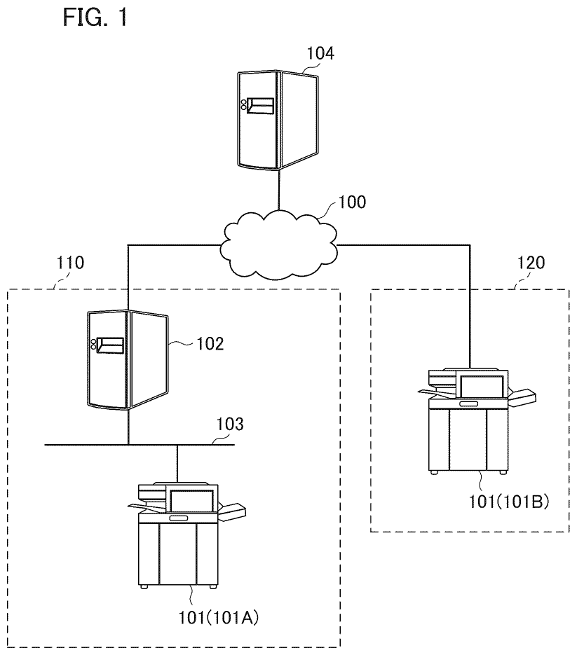

FIG. 1 is a diagram showing the configuration of a management system that includes an image forming apparatus according to a First Embodiment.

The management system includes a management server 104, a monitoring apparatus 102, and, for example, a plurality of image forming apparatuses 101 (101A and 101B). The management server 104 is installed on the side providing the service, and the monitoring apparatus 102 and the image forming apparatuses 101 are installed in a customer environment. In the following explanations, a concept that includes a customer is referred to as a “user.”

The monitoring apparatus 102 and the image forming apparatus 101A are connected to the management server 104 via a Wide Area Network (WAN) 100 as a second network. The monitoring apparatus 102 and the image forming apparatus 101A are connected via a Local Area Network (LAN) 103 as a first network. The monitoring apparatus 102 is installed at the boundary between the WAN 100 and the LAN 103 and has a proxy server function to relay communication between the image forming apparatus 101A and the management server 104. Typically, the Internet is used as the WAN 100. Typically, an intranet is used as the LAN 103.

An image forming apparatus 101 is a network device and functions as an “information processing apparatus.” Hereinafter, an image forming apparatus is referred to as a “device.” A device 101 is configured by, for example, a printer, a scanner, or a multifunction device and the like. In addition, the device 101 transmits operation information to the management server 104 in accordance with the monitoring of the monitoring apparatus 102. Operation information includes various data recorded in association with the use of a printer function or a scanner function of the device 101, such as status information regarding faults and consumables, counter information, log information, and the like. It should be noted that in the example shown in FIG. 1, although only one device 101 is connected to the monitoring apparatus 102, a plurality of devices may be connected.

The management server 104 centrally manages the monitoring apparatus 102 and the plurality of devices 101. As described later, the management server 104 manages device information of the device 101 and the above-described operation information and the like by communicating with the monitoring apparatus 102 and the device 101. In addition, the management server 104 accepts registration and setting of the device 101, and changes thereto. The management server 104 may be a configuration comprising one computer, or may also be a configuration comprising a plurality of computers.

The monitoring apparatus 102 has a function of monitoring and protecting the device 101A. As a primary monitoring function, the monitoring apparatus 102, for example, acquires the operation information of the device 101A as described above and transmits the operation information to the management server 104. The monitoring apparatus 102, having the function to collect such operation information, is also referred to as an “aggregation apparatus.”

Device 101A and device 101B are installed in different installation environments 110 and 120, that is, installation environments configured by different types of networks. The installation environment 110 exemplified in FIG. 1 is a company intranet environment, and the installation environment 120 exemplified in FIG. 1 is an Internet direct connection environment. Hereinafter, the installation environment 110 is referred to as a company intranet environment 110, and the installation environment 120 is referred to as an Internet direct connection environment 120.

The company intranet environment 110 is an environment in which devices 101 are connected via a LAN within a company (LAN 103). Communication by the device 101A within the company intranet environment 110 with the management server 104 connected to the WAN 100 and external devices (not shown) is monitored and protected by the monitoring apparatus 102. Therefore, in the company intranet environment 110, threats such as access to the device 101A by attackers via the WAN 100 are relatively reduced.

In contrast, a monitoring apparatus 102 is not installed in the Internet direct connection environment 120. In the Internet direct connection environment 120, the device 101B is directly connected to the WAN 100, and the Internet direct connection environment 120 is an environment in which communication is performed. Therefore, the device 101B needs to take measures against threats such as access by attackers via the WAN 100 by using a personal firewall function within the device 101B and the like.

In the present embodiment, the environment type of the installation environment of the device 101 also assumes an environment type separate from the “company intranet environment (110)” and the “Internet direct connection environment (120)”. For example, an “Internet prohibition environment”, an “in-home environment”, a “public space environment”, and a “highly confidential information management environment” (not shown) are assumed. For each of these above six types of environments, different security settings should be applied to the device 101. For example, a file sharing function is a function for sharing files on a network within an environment, and in an environment in which the network within the environment is shared by unspecified users, to prevent information leakage, the file sharing function is preferably disabled. That is, except for in a private network environment in which the network in the environment is shared by specified users, disabling the file sharing function is recommended. In the present embodiment, the types of private network environments are the “company intranet environment,” the “Internet prohibition environment,” and the “in-home environment.” Therefore, it is recommended that, aside from these environments, the file sharing function be disabled in the “Internet direct connection environment,” the “public space environment,” and the “highly confidential information management environment.” An example setting related to file sharing functionality is a Server Message Block (SMB) server setting.

It should be noted that the definition of the above-described environment types is not intended to limit the present disclosure, and some or other environment types described in the present embodiment may be defined. For example, installation of the device 101 in a company is assumed, and use environments may be classified according to the type of business, such as finance business or government and municipal offices.

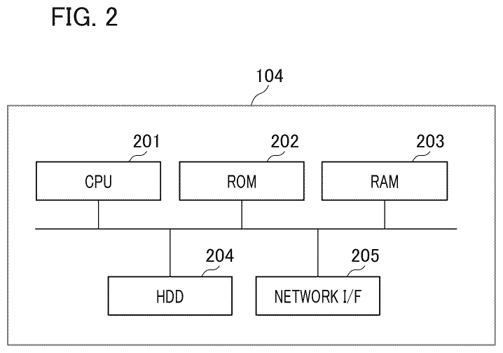

FIG. 2 is a diagram showing an example of a hardware configuration of the management server 104. The CPU 201 executes various control processing by reading control programs stored in the ROM 202. This control includes executing programs for realizing processes shown in the flowchart described later. A RAM 203 is the main memory of the CPU 201 and is used as a temporary storage area such as a work area. A Hard Disk Drive (HDD) 204 stores various data and programs. A network interface (I/F) 205 connects the management server 104 to the network, and transmits and receives various types of information with other apparatuses via a network.

It should be noted that because the management server 104 can interact (for example, communicate) with other apparatuses such as a device 101 and the monitoring apparatus 102 without having a User Interface (UI), a UI is not shown. However, the management server 104 may include hardware such as a keyboard, a pointing device, a display, and the like.

Because the hardware configuration of the monitoring apparatus 102 is similar to that of the management server 104, a description thereof will be omitted.

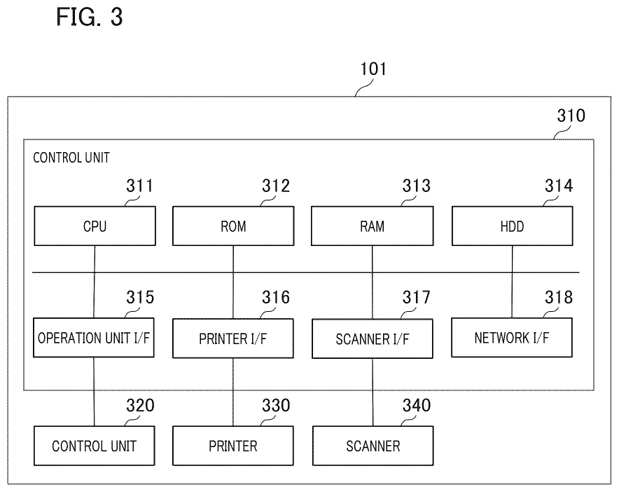

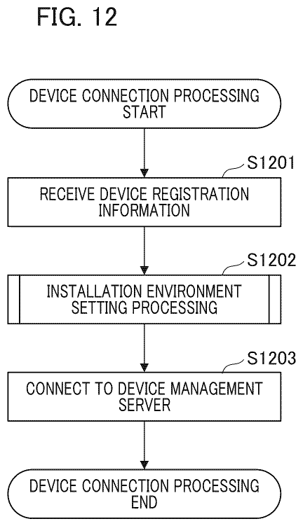

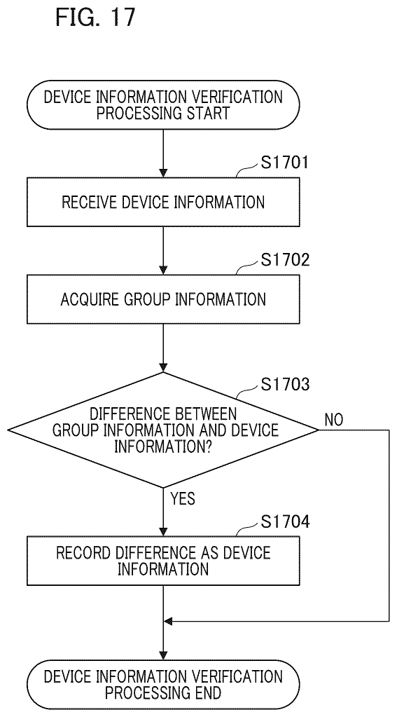

FIG. 3 is a diagram showing an example of a hardware configuration of a device 101. A control unit 310 that includes a CPU 311 controls the operation of the entire device 101. A ROM 312 stores programs executed by the CPU 311. The CPU 311 reads control programs stored in the ROM 312, and performs various kinds of control such as image reading control and image transmission control. This control also includes execution of a program for realizing processes shown in the flowchart (for example, FIG. 12, and FIG. 17) to be described below. The RAM 313 is used as a temporary memory area that serves as the main memory, a work area, and the like of the CPU 311. An HDD 314 is a storage apparatus that stores image data, various programs, and various kinds of setting information.

An operation unit interface (I/F) 315 connects an operation unit 320 and the control unit 310 with each other. The operation unit 320 includes a liquid crystal display unit having a touch panel function, various hardware keys, and the like. The operation unit 320 functions as a display unit that displays information to a user, and as a reception unit that receives instructions from the user. A printer I/F 316 connects a printer 330 and the control unit 310 with each other. Image data to be printed by the printer 330 is transferred from the control unit 310 via the printer I/F, and then output to a recording medium by the printer 330. A scanner I/F 317 connects a scanner 340 and the control unit 310 with each other. The scanner 340 reads a document placed on a document platen (not shown), and generates image data. The generated image data is input to the control unit 310 via the scanner I/F 317. A network cable (not shown) is connected to a network I/F 318, and communication is performed with an external apparatus (not shown) on the LAN 103. In the present embodiment, the network I/F 318 is assumed to be a communication interface that performs wired communication, but it is not limited to this, and may be a wireless communication interface. It should be noted that, although the network I/F 318 of the device 101A is connected to the LAN 103, the connected network differs depending on the installation environment. For example, the device 101B is directly connected to the WAN 100.

It should be noted that in FIGS. 2 and 3, not only CPU 201 and CPU 311, but also a Programmable Logic Device (PLD) such as a Field Programmable Gate Array (FPGA) may be provided. Alternatively, an Application Specific Integrated Circuit (ASIC) may be used. Furthermore, a storage apparatus is not limited to the HDD 204 and HDD 314, and other storage apparatuses such as a flash memory, optical recording devices, or magneto-optical recording devices, and the like may be used.

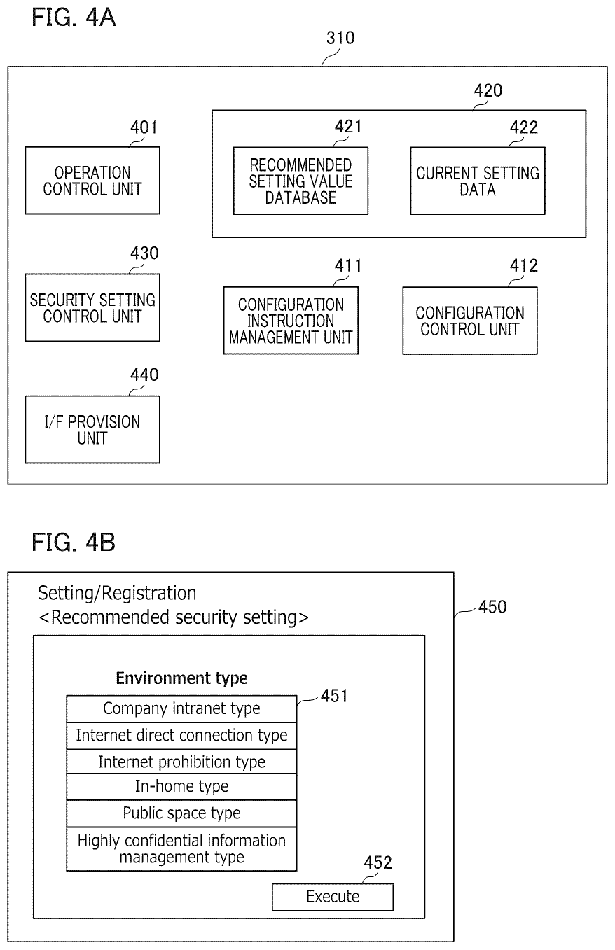

FIG. 4A is a diagram showing an example of the software configuration of a device 101. It should be noted that each unit illustrated in FIG. 4A is implemented by the CPU 311 executing a program corresponding to each unit that is stored in the ROM 312. An operation control unit 401 displays on the operation unit 320 a screen for the user to operate. Furthermore, the operation control unit 401 detects user operations and changes the screen or updates the display based on the detection results. A configuration instruction management unit 411 stores configuration change instructions received from the management server 104 or the monitoring device 102, and requests a setting of the configuration (or a change thereof) from a configuration control unit 412 based on the content thereof. Setting of the configuration or a change thereof refers to the settings required for the device 101 to start communication by connecting with the management server 104 or the monitoring device 102 (for example, settings based on device registration information to be described later, proxy information settings, and the like) or changes to these settings. The configuration control unit 412 performs the setting of the configuration of the device 101 or a change thereof in accordance with the instructions from the configuration instruction management unit 411.

The data storage unit 420 stores data in the HDD 314 or reads data from the HDD 314 according to requests from the operation control unit 401, the configuration control unit 412, and other control units. The data storage unit 420 stores information related to settings that determine the operation of the device 101, in addition to information related to settings of security functions. Specifically, the data storage unit 420 stores a recommended setting value database 421 and current setting data 422.

The recommended setting value database 421 is a database that includes setting values of security functions associated with the environment types described above. Specifically, as shown in Table 1 below, the recommended setting value database 421 is a database in which combinations of setting items of security functions suited to the installation environment of the device 101 and the setting values thereof are associated with a plurality of environment types. The vertical columns of Table 1 indicate the setting items of a plurality of security functions. Hereafter, “setting items of security functions” may simply be referred to as “setting items.” For example, there are seven setting items, “Encryption of communication paths,” “Disabling of legacy protocols,” “Enabling of personal firewall,” “Security enhancement of authentication,” “Measures against physical attacks,” “Disabling of file sharing function,” and “Disabling of external storage apparatuses.” The horizontal rows show the six environment types described above.

TABLE 1

| | | | | | | Highly |
|---|---|---|---|---|---|---|
| | | | Internet | | | confidential |
| | Company | Internet | direct | | | information |
| | intranet | prohibition | connection | In-home | Public space | management |
| | environment | environment | environment | environment | environment | environment |
| Encryption of | On | | On | On | On | On |
| communication | | | | | | |
| paths | | | | | | |
| Disabling of | On | | On | On | On | On |
| legacy protocols | | | | | | |
| Enabling of | | | On | On | On | On |
| personal firewall | | | | | | |
| Security | On | | On | On | On | On |
| enhancement of | | | | | | |
| authentication | | | | | | |
| Measures against | | | | On | On | On |
| physical attacks | | | | | | |
| Disabling of | | | On | | On | On |
| file sharing | | | | | | |
| function | | | | | | |
| Disabling of | On | On | On | On | On | On |
| external storage | | | | | | |
| apparatuses | | | | | | |

In Table 1, the setting values are shown as “On”. As a setting value, in addition to “On”, there is also “Off”, which is not shown in Table 1. In Table 1, a setting item for which the setting value is blank indicates that the setting item does not have a recommended setting value. In the setting process (or the change process thereof) of the installation environment (environment type) described below, the setting values for the blank setting items are not changed, and the setting values before the change are retained. In the present embodiment, the recommended setting value database 421 is, for example, defined in advance by the vendor of the device 101 and stored in the data storage unit 420. In Table 1, all recommended setting values except those in the blank boxes are made as “On”, although there may be recommended setting values that are made as “Off”. The HDD 314 (or the ROM 312), the data storage unit 420, and the like mainly function as storage units.

The seven security function setting items in Table 1 are merely an example. For example, one or more setting items other than those seven can be substituted for at least one of those seven setting items or can be added to those seven setting items. Alternatively, the recommended setting value database 421 may be comprised of up to six of those seven setting items.

The current setting data 422 is data that includes information that indicates the environment type currently applied to the device 101 (for example, an ID indicating the environment type), and combinations of setting items and setting values for each security function. At the time of the setting processing of the security function, the current setting data 422 is rewritten (overwritten). Then, for example, by the restart of the device 101, the overwritten current setting data 422 is read by a program, and the device 101 operates under the newly applied security settings.

A security setting control unit 430 performs batch setting of the security function settings corresponding to the environment type in a case in which the device 101 initiates a connection with the management server 104 or the monitoring apparatus 102. Here, to perform batch setting means that the setting values of a plurality of setting items corresponding to the environment type are applied to the device 101 at once. In addition, the security setting control unit 430, as will be described later with reference to FIG. 4B, performs batch setting of the settings of security functions that correspond to the environment type that has been manually selected by the user, received from the operation control unit 401. Furthermore, the security setting control unit 430 checks the content of the configuration instructions via the configuration instruction management unit 411 and determines whether or not to change each setting item of the security functions. It should be noted that a case in which the security setting control unit 430 disallows a change will be explained in a second embodiment (an embodiment in which the user manually changes security settings).

An I/F provision unit 440 provides an Application Programming Interface (API) necessary for an external program to either reference the data storage unit 420 or to instruct the security setting control unit 430 to perform processing.

An environment type setting screen 450 shown in FIG. 4B is a screen displayed on the operation unit 320 by the operation control unit 401. An environment type list button 451 is a button for the user to select an environment type. On the environment type setting screen 450, the user selects an environment type corresponding to the installation environment of the device 101 using the environment type list button 451, and an operation of pressing an execute button 452 is performed. In the present embodiment, the user performs security settings by selecting from among the six environment type options described above. Thus, security settings can be performed also through manual operations by the user. In this manner, security settings can also be performed through manual operation by the user. The operation control unit 401 detects a user operation and transmits information indicating a selection result by the user to the security setting control unit 430.

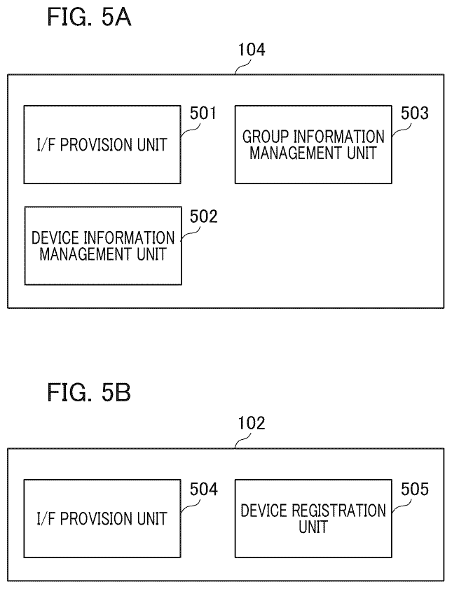

FIG. 5A is a diagram showing an example of a software configuration of a management server 104. Each unit illustrated in FIG. 5A is implemented by the CPU 201 executing a program corresponding to each unit that is stored in the ROM 202. The management server 104 includes an I/F provision unit 501, a device information management unit 502, and a group information management unit 503. The I/F provision unit 501 provides an API for an external apparatus (not shown) to use the management server 104, enabling data transmission and reception between the monitoring apparatus 102, the device 101, and the external apparatus. In addition, the I/F provision unit 501 provides a web application for managing device information of the device 101. In this manner, the management server 104 can be accessed by using a web browser from, for example, a client PC (not shown) or the like owned by the user. For each device 101, the device information management unit 502 holds information of the apparatus, owner information, used cloud service, and the like. The group information management unit 503 holds setting information of each monitoring apparatus 102, association information between the monitoring apparatus 102 and the device 101, and the like.

FIG. 5B is a diagram showing an example of a software configuration of a monitoring apparatus 102. Each unit shown in FIG. 5B is implemented by the CPU 201 executing a program corresponding to each unit that is stored in the ROM 202. The monitoring apparatus 102 includes an I/F provision unit 504 and a device registration unit 505. The I/F provision unit 504 enables communication between the monitoring apparatus 102 and an external device 101 or the management server 104. The device registration unit 505 receives group information, as described later, from the management server 104 and based on this information, detects whether the device 101 to be managed exists on the network. In addition, the device registration unit 505 primarily instructs the detected device 101 to either set or modify the environment type (security functions), and performs registration to the management server 104.

It should be noted that hereinafter, with respect to the environment type, “setting” also includes a “change” of the environment type. As described later, after the setting processing of the installation environment based on the recommended setting value database 421 has been performed once or more, setting the environment type, regardless of whether it is automatic by the system or manual by the user, constitutes a “change”.

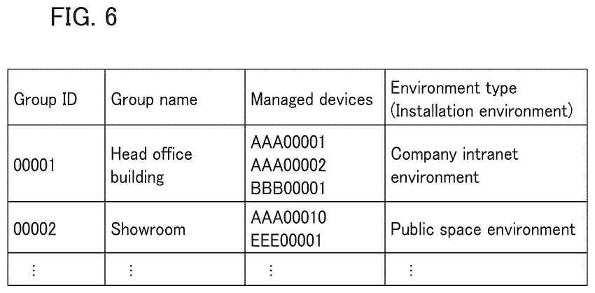

FIG. 6 is a diagram showing an example of group information held by the group information management unit 503. “Group ID” is a character string that uniquely identifies the monitoring apparatus 102. One group ID is assigned an installation environment that is the environment of one network (LAN). “Group name” is an arbitrary name set for each monitoring apparatus 102. “Managed devices” are identifiers of devices 101 that are managed by the monitoring apparatus 102. “Environment type” refers to the six environments shown in Table 1, and indicates the type of environment in which the monitoring apparatus 102 is installed.

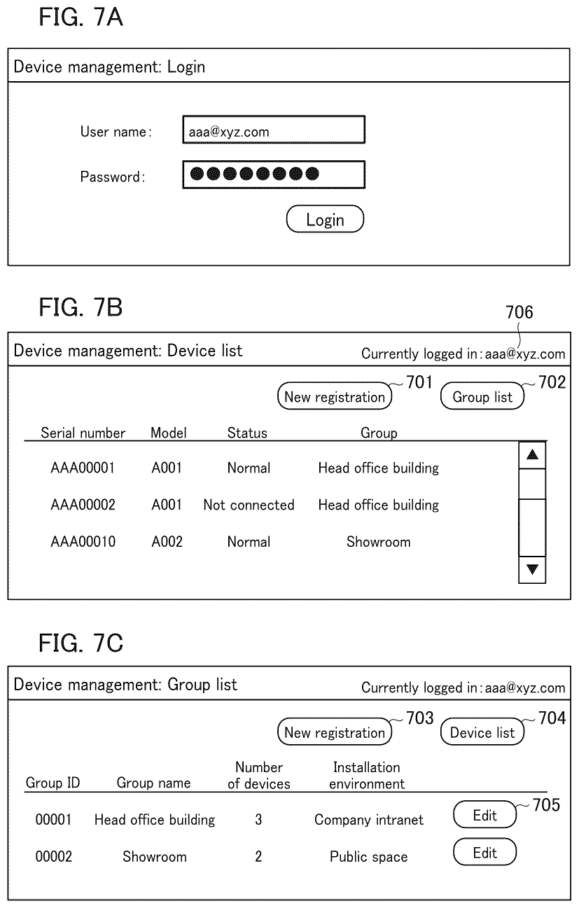

FIG. 7A-7C are diagrams showing examples of web application screens of a management server 104. As described above, a user can receive the provision of these web application screens by using a PC (not shown). FIG. 7A shows an example of an authentication screen provided by the management server 104. By entering a username and password to log in, FIG. 7B is transitioned to.

FIG. 7B shows an example of a device list screen. For each device 101, information such as “Serial Number”, “Model”, “Status (operational status)”, “Belonging Group”, and the like, is displayed. Device information and group information are managed separately for each “Tenant”, which is a virtual organization. Tenants are, for example, divided by domain names of email addresses 706 used as usernames. As one initial setting when starting the use of the device 101, the device 101 is registered with the tenant. Thereby, only devices registered with the tenant to which the logged-in user belongs are displayed in FIG. 7B.

A new registration button 701 is a button for newly registering a device 101, and pressing this button transitions to a new registration screen. A group list button 702 is a button for displaying a group list, and pressing the group list button 702 transitions to the screen shown in FIG. 7C.

FIG. 7C shows an example of a group list screen. The group list screen primarily displays the group information shown in FIG. 6. Specifically, on the group list screen, for each monitoring apparatus 102, the information of “Group ID,” “Group Name,” “Number of devices” 101 to be managed, and “Installation Environment” (environment type) is displayed.

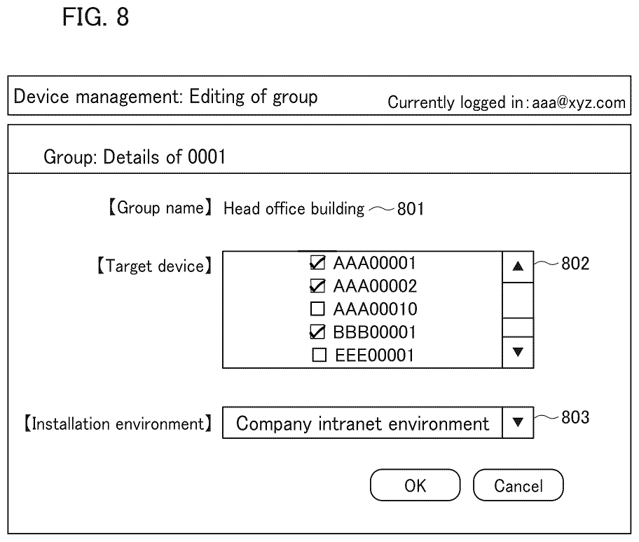

A new registration button 703 is a button for newly registering a group, and upon pressing the new registration button 703, a new registration screen (not shown) is transitioned to. A device list button 704 is a button for displaying the device list, and upon pressing the device list button 704, the device list screen shown in FIG. 7B is transitioned to. An edit button 705 is a button for editing group information, and upon pressing the edit button 705, the group edit screen shown in FIG. 8 is transitioned to.

FIG. 8 is a diagram showing an example of a web application screen of a management server 104, and is an example of a group edit screen. Here, the user can edit the settings of the monitoring apparatus 102. A group name 801 is an arbitrary name for the user to identify the group. A target device selection area 802 is an area for the user to select a device 101 that is to be managed by the monitoring apparatus 102. A user can select one or more devices 101 registered under the tenant to which the user has logged in. An environment type selection area 803 is an area for the user to select the environment type of the network in which the monitoring apparatus 102 is installed. One of the six environment types shown in Table 1 may be selected as the environment type.

It should be noted that in each screen shown in FIGS. 7A to 7C, and FIG. 8, other information may be additionally displayed, or some of the above-described information items may not be displayed.

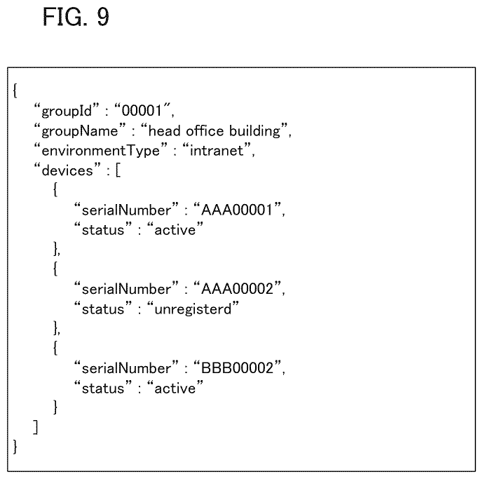

FIG. 9 is a diagram showing an example of group information received by the monitoring apparatus 102 from the management server 104. The monitoring apparatus 102 receives group information from the management server 104 at a predetermined timing via the I/F provision unit 504 and stores the group information in the device registration unit 505.

Similar to the example in FIG. 6, the group information includes information of the group name (groupName), the environment type (environmentType), and three target devices 101 (devices) as settings for group ID (groupId)=00001. Information of the target devices 101 includes a serial number (serialNumber) and status (status). A status “active” indicates that the device 101 has been registered with the management server 104 and is operating normally. A status “unregistered” indicates that the device 101 is not registered with the management server 104.

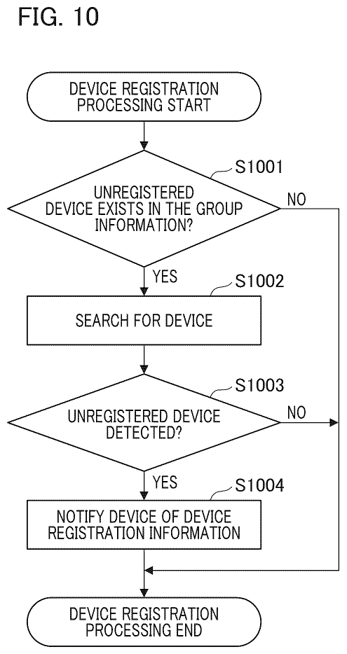

Next, device registration processing for the management server will be explained. Device registration processing is processing by the monitoring apparatus 102 for the purpose of registering the device 101 (101A) with the management server 104. FIG. 10 is a flowchart showing device registration processing by the monitoring apparatus 102. Each operation (step) shown in this flowchart is implemented by the CPU 201 loading a control program stored in the ROM 202 or the HDD 204 to the RAM 203 and executing the program. This processing is executed at a predetermined timing, such as periodically or after receiving group information shown in FIG. 9 from the management server 104.

In step S1001, the device registration unit 505 refers to the group information received from the management server 104, and checks whether an unregistered device 101 exists. In a case in which an unregistered device 101 exists, the processing proceeds to step S1002, and in a case in which an unregistered device 101 does not exist, the device registration processing is terminated.

In step S1002, the device registration unit 505 searches for unregistered devices 101 connected on a network (in this case, for example, the LAN 103) by using a known communication technique such as broadcast communication.

In step S1003, the device registration unit 505 determines whether or not an unregistered device 101 was detected as a processing result of step S1002. In a case in which an unregistered device 101 was detected, the processing proceeds to step S1004, and in a case in which an unregistered device 101 was not detected, the device registration processing is terminated.

In step S1004, the device registration unit 505 notifies the detected device 101 of the device registration information for registration in the management server 104. Device registration information includes information required for registration and environment type information included in the group information.

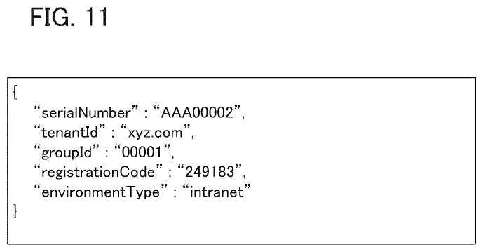

FIG. 11 is a diagram showing an example of device registration information that the monitoring apparatus 102 notifies to the device 101 (101A). The example shown in FIG. 11 is device registration information for the device 101 having the serial number (serialNumber)=AAA00002. The tenant ID (tenantId) is the identifier of the tenant in which the monitoring apparatus 102 is registered, and is the tenant in which the device 101, upon receiving the device registration information, is to register itself. The group ID (groupId) is identification information (ID) that identifies the monitoring apparatus 102. The registration code (registrationCode) is a keyword the device 101 uses to register itself in the management server 104. The environment type (environmentType) indicates the environment type of the network that should be set for the device 101. This is the information of the environment type among the group information shown in FIG. 9.

FIG. 12 is a flowchart showing the device connection processing executed by a device 101 (101A) in a case in which the device 101 receives registration information. This processing is for communicatively connecting the device 101A to the management server 104. Each operation (step) shown in this flowchart is implemented by the CPU 311 loading a program stored in the ROM 312 or the HDD 314 to the RAM 313 and executing the program.

In step S1201, the configuration instruction management unit 411 receives device registration information from the monitoring apparatus 102. At this time, the CPU 311, the configuration instruction management unit 411, the network I/F 318 and the like mainly function as receiving units.

In step S1202, the security setting control unit 430 mainly performs setting processing of the installation environment (environment type) based on the device registration information received at step S1201. This is processing for applying the environment type, corresponding to the installation environment in which the monitoring apparatus 102 is installed, to the device 101. At this time, the CPU 311, the configuration instruction management unit 411, the security setting control unit 430, and the like mainly function as setting units to perform security settings corresponding to the environment type.

In step S1203, the configuration instruction management unit 411 performs connection processing to the management server 104 based on the device registration information received at step S1201. For example, the configuration control unit 412 performs communication for initiating a connection to the management server 104 by using the registration code included in the device registration information. At this time, the CPU 311, the functional configuration control unit 412, the network I/F 318, and the like mainly function as communication units.

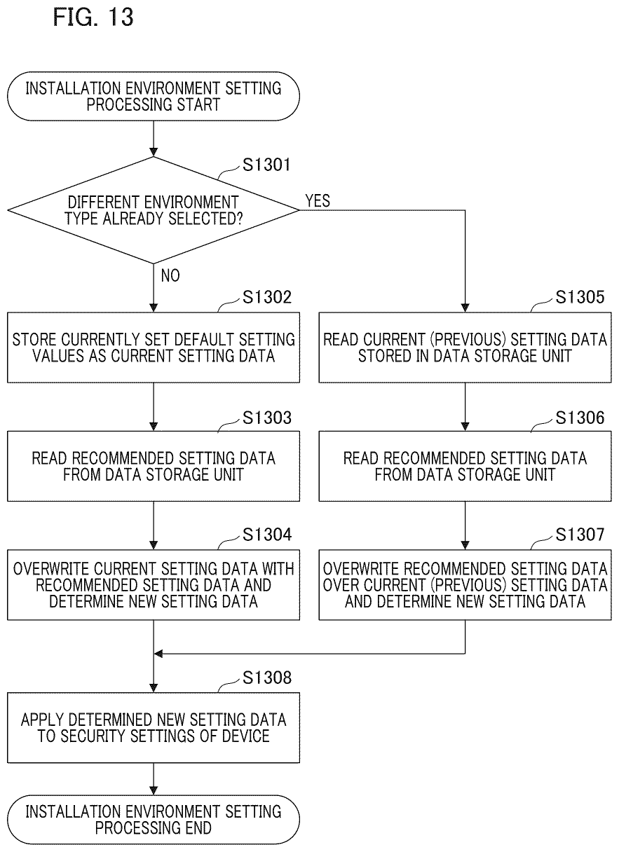

FIG. 13 is a flowchart showing the installation environment setting processing for the device 101 in step S1202 of FIG. 12.

In step S1301, the security setting control unit 430 determines whether or not a batch setting of security functions of a different (another) environment type has already been applied one or more times from the default security setting. A batch setting of a security function of another environment type may be a setting of a security function based on the recommended setting value database 421, or may be a setting of a security function based on other data (not shown). In step S1301, whether or not the current setting data 422 is stored in the data storage unit 420 is used as the determination criterion.

The security setting control unit 430 determines that a security setting of a different (another) environment type has already been applied in a case in which the current setting data 422 is stored in the data storage unit 420. In a case in which the current setting data 422 is not stored in the data storage unit 420, the security setting control unit 430 determines that a security setting of another environment type has not been applied. In the latter case, the security setting of the current time remains in the default state. In a case in which the current setting data 422 is stored, the processing proceeds to step S1305, and in a case in which the current setting data 422 is not stored, the processing proceeds to step S1302.

In step S1302, the security setting control unit 430 saves the combination of the currently applied default setting items and setting values of the security functions in the data storage unit 420 as the current setting data 422.

In step S1303, the security setting control unit 430 reads recommended setting data from the recommended setting value database 421 of the data storage unit 420. “Recommended setting data” refers to each setting value of the security functions corresponding to the environment type of the network to which the device 101 is currently attempting to connect. In this case, the security setting control unit 430 recognizes the recommended setting data corresponding to that environment type by referring to the “environment type” information of the device registration information that was received from the monitoring apparatus 102 in step S1201.

In step S1304, the security setting control unit 430 reads the current setting data 422 that was stored in the data storage unit 420 in step S1302. Then, by overwriting the recommended setting data onto the current setting data 422, the security setting control unit 430 determines new setting data (new setting values). That is, for a setting item of a certain security function, in a case in which the recommended setting data has a value (in the case of “On” or “Off”), the current setting data 422 is changed to the recommended setting value. In a case in which the recommended setting data does not have a value (as indicated by a blank space in Table 1), the new setting value remains unchanged from the value of the current setting data 422.

By the above processing, the security setting control unit 430 determines a combination of setting items and setting values for the security function to be newly set.

In contrast, in step S1305, the security setting control unit 430 reads the current setting data 422 stored in the data storage unit 420. This corresponds to, for example, the recommended setting data that was previously stored.

Because step S1306 is similar to step S1303, an explanation thereof is therefore omitted.

In step S1307, the security setting control unit 430 uses the current (previous) setting data 422 read in step S1305 and the recommended setting data read in step S1306 to determine the combination of setting items and setting values of the security functions that are to be newly set. The security setting control unit 430 determines the data to be newly set by overwriting the recommended setting data over the current setting data 422. That is, for a setting item of a certain security function, in a case in which the recommended setting data has a value (in the case of “On” or “Off”), the current setting data 422 is changed to the recommended setting value. In a case in which the recommended setting data does not have a value (as indicated by a blank space in Table 1), the new setting value remains unchanged from the value of the current setting data 422.

Through the above-described processing, the security setting control unit 430 determines newly set combinations of setting items and setting values for the security functions.

In step S1308, the security setting control unit 430 applies the new setting data as the security setting of the device 101. In addition, the security setting control unit 430 saves the new setting data in the data storage unit 420 as the current setting data 422.

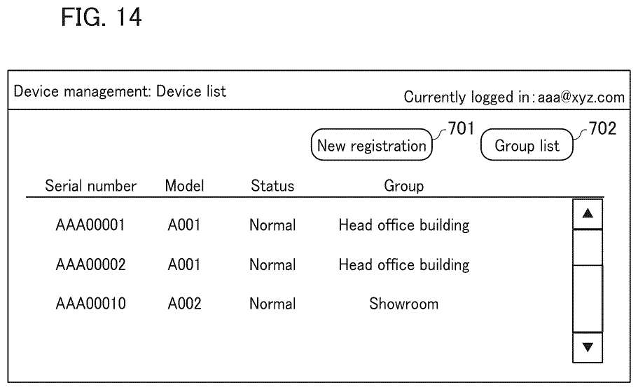

FIG. 14 is a diagram showing an example of a device list screen of the management server 104 after the device connection processing shown in FIG. 12 has been completed. In FIG. 14, parts that are identical to those in FIG. 7 are designated with the same reference numerals, and a description thereof is omitted. The screen shown in FIG. 14, compared to FIG. 7B, shows that the status of the device 101 with serial number “AAA00002” has changed to “Normal” and that the connection has been completed . . . .

In this manner, in the present embodiment, for example, in an environment in which the monitoring apparatus 102 monitors a plurality of devices 101, in a case in which use is begun by connecting the devices 101 to the management server 104, performing appropriate security settings according to the installation environment of the devices 101 becomes possible. Thereby, the security of the devices 101 can be improved. This is particularly beneficial in a case in which a plurality of devices 101 are used in the same network environment by using a monitoring apparatus 102 having a proxy server function. In a case in which the security settings are different for each of the devices 101, because of the possibility of a security hole being generated, it is desirable to ensure that the same security level is enforced for each device.

In addition, in the present embodiment, because a device 101 performs security settings automatically, the user no longer needs to perform security settings by manually selecting security settings by using the environment type setting screen 450, as shown in FIG. 4B. Thus, convenience is improved when starting to use the device 101 in a new installation environment.

In addition, for example, the technology of the Japanese Patent Application Laid-Open No. 2007-185814 does not take into account settings of security functions that are appropriate for the installation environment on a network of an image forming apparatus, making it difficult for the user to determine which security level should be applied to the installation environment of the image forming apparatus. In contrast, in the present embodiment, because security functions at a level appropriate for the installation environment of the devices 101 are automatically set to the devices 101, there is no need for the user to be conscious of the security level.

### Second Embodiment

Next, a second embodiment will be explained. The second embodiment involves the user manually changing the environment type after the security settings (automatic batch setting) corresponding to the environment type have been performed in the device connection processing as was explained in the above-described first embodiment. In the following explanations, parts that are similar to the First Embodiment are either omitted or simplified, and differences are primarily explained.

As described above, the user can manually change the environment type by selecting the environment type on the environment type setting screen 450 shown in FIG. 4B and pressing the execute button 452. In the present embodiment, the CPU 311, the operation control unit 401, and the like mainly function as reception units that accept changes of the environment type that are made by the user.

Even in this manual change process, the processing shown in FIG. 13 is executed. The environment type selected by the user is detected by the operation control unit 401 on the operation unit 320, and this processing is implemented by the security setting control unit 430 receiving that information from the operation control unit 401. Here, the recommended setting data in steps S1303, S1304, S1306, and S1307 in FIG. 13 becomes a combination of security setting items and setting values corresponding to the environment type selected by the user. The security setting control unit 430 performs the processing of steps S1303 and S1306 by extracting the recommended setting data corresponding to that selected environment type from the recommended setting value database 421 stored in the data storage unit 420.

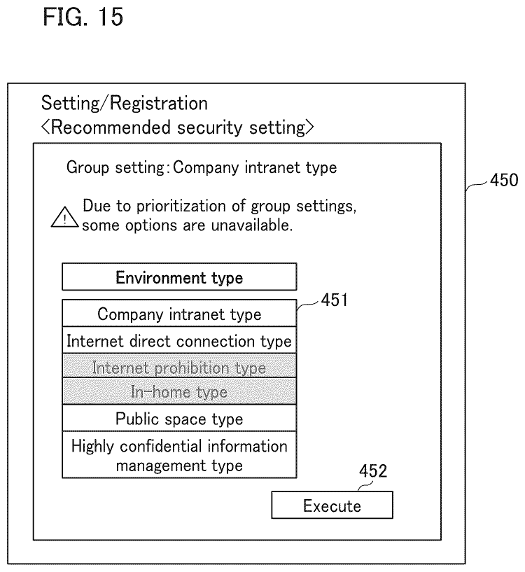

In the present embodiment, in the environment type setting screen 450, the operation control unit 401 restricts changes by the user to at least one of the environment types in the environment type list button 451, based on the device registration information (FIG. 11) received by a device 101. FIG. 15 is a diagram showing an example of a screen provided by a device 101 in a case in which changes by the user to one or more environment types are restricted. In the present example, changes to the “Internet Prohibition Type” and “In-Home Type” are restricted (prohibited), and their selection regions are grayed out. For example, in the First Embodiment, security settings corresponding to the company intranet environment as the environment type were applied to the device 101A. Thereafter, in a case in which the user attempts to change the environment type of the device 101A without changing the network connection destination, that is, the actual installation environment, changes to the Internet Prohibition Type and In-Home Type, which are unsuitable for the security settings of a company intranet environment, are restricted. The criteria for whether to restrict changes may be determined in advance by the designer of the system. Alternatively, one of the criteria for restricting changes could be the number of different setting values for the Internet Prohibition Type or In-Home Type being relatively large (for example, exceeding a threshold value) compared to the security function settings corresponding to the company intranet environment.

In contrast, even for the device 101A installed in a company intranet environment, there could be a case in which the device 101A is used by visitors to an office within the company, similar to a device 101 installed in a “public space environment.” Alternatively, even for a device 101A that is installed in a company intranet environment, there could be a case in which it is used as a dedicated device for handling certain confidential documents, installed in a “highly confidential information management environment”. To accommodate these cases, changes to the “public space type” or “highly confidential information management type” are not restricted.

It should be noted that even for a device 101 installed in a company intranet environment, for example, a case in which the device 101 is temporarily or exceptionally connected to the WAN 100 via a mobile router is conceivable. In such a case, by manual operation of the user, the environment type of the device 101 is changed to “Internet Direct Type”, and the corresponding security settings are applied to the device 101.

Alternatively, as explained in the above-described First Embodiment, after the security settings corresponding to the environment type have been performed in the device connection process (automatic batch setting), the user may be able to manually change the setting values of the security functions corresponding to the environment type individually. That is, for example, the setting values for the six security functions shown in Table 1 can be manually changed. Primarily, the CPU 311, the operation control unit 401 and the like function as reception units that accept changes to a plurality of setting values of security functions by the user. In the present embodiment, the operation control unit 401 provides, for example, a screen (not shown) to manipulate the setting values of the security function after the automatic batch setting has been performed, and the user changes at least one setting value on that screen. The security setting control unit 430 applies the new security settings to the device 101 according to the content of the setting (change) of that setting value. The data storage unit 420 stores these new security settings as the current setting data 422.

In that case, the security setting control unit 430 can also restrict (prohibit) changes to at least one of the setting values among the setting values of those security functions. For example, changing the setting item “Encryption of communication paths”, which is common to all environment types except the “Internet Prohibition Type” and “In-Home Type” that were restricted in FIG. 15, from “On” to “Off” may be disallowed. Thus, it is possible to prevent users from changing important security features.

In this manner, in the present embodiment, while enabling changes to security settings by a manual operation of the user, in a case in which security is prioritized over the content the user is trying to change, such changes are disallowed. Thus, user convenience is improved while maintaining the high security of the device 101.

### Third Embodiment

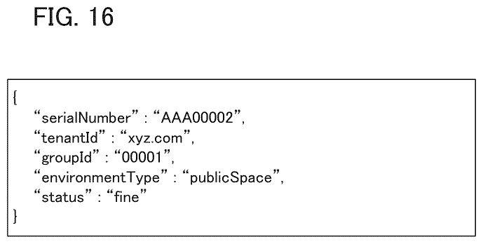

Next, a third embodiment will be explained. FIG. 16 is a diagram showing an example of device information that a device 101 notifies to the management server 104. The device information is notified at a predetermined timing, such as after the installation environment setting processing shown in FIG. 13 or at regular intervals.

The serial number (“serialNumber”) is an identifier of the device 101. The tenant ID (“tenantId”) and group ID (“groupId”) are identifiers for the tenant and the monitoring apparatus 102 to which the device 101 belongs, and are the same as the device registration information received in FIG. 11. The environment type (“environmentType”) is the environment type of the current installation that is set for the device 101, which in the example of FIG. 16 is “publicSpace”, that is, the public space type. This differs from the environment type “company intranet” of the device registration information shown in FIG. 11, and indicates that the user has manually changed the environment type, as explained in the Second Embodiment. The status (“status”) indicates the operational status of the device 101, and “fine” means that the device 101 is operating normally.

FIG. 17 is a flowchart showing device information verification processing by a management server. Each operation (step) shown in this flowchart is implemented by the CPU 201 loading a control program stored in the ROM 202 or the HDD 204 to the RAM 203 and executing the program so as to implement various control units.

In step S1701, the device information management unit 502 receives device information from the device 101.

In step S1702, the device information management unit 502 acquires group information from the group information management unit 503.

In step S1703, the device information management unit 502 compares the device information received in step S1701 with the group information acquired in step S1702. In a case in which there is a difference, the processing proceeds to S1704, and in a case in which there is no difference, the processing ends. For example, in a case in which the group information shown in FIG. 9 and the device information shown in FIG. 16 are compared, it is determined that the setting of the environment type is different for the device 101 having the serial number “AAA00002”.

In step S1704, the device information management unit 502 records, as device information, that there was a difference between the device information and the group information.

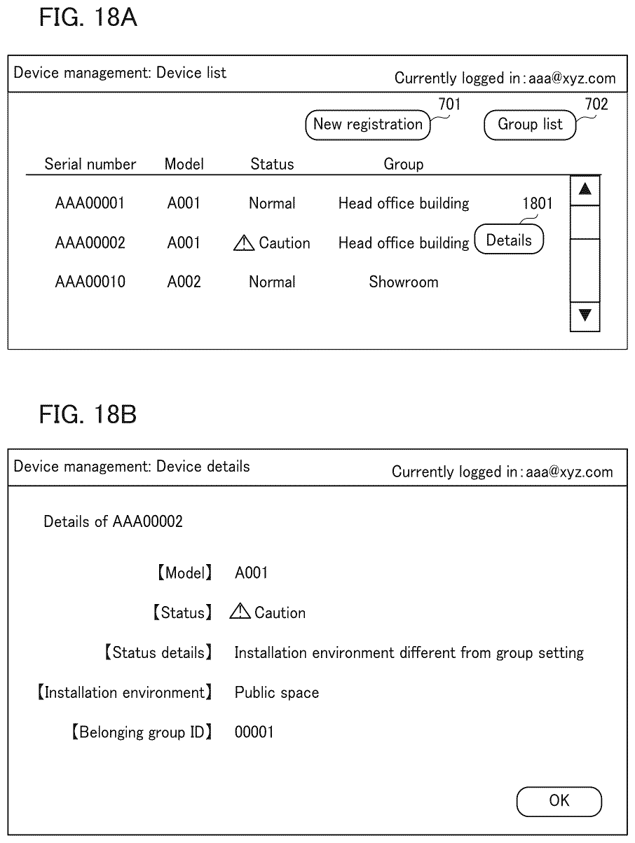

FIGS. 18A and 18B are diagrams showing examples of Web application screens of a management server 104. Parts that are identical to those in FIG. 14 are designated with the same reference numerals, and a description thereof is omitted.

FIG. 18A is a device list screen. The difference from FIG. 14 is that the status of the image forming apparatus having the serial number “AAA00002” is “Caution”. As described above, this indicates that a difference between the device information of serial number “AAA00002” and the group information has been recorded in step S1704. When a detail button 1801 is pressed, the device list screen transitions to the device detail screen of FIG. 18B.

FIG. 18B is a device detail screen. This screen displays information of the selected device 101, such as “Model”, “Status (operational status)”, and “Belonging Group”. Because the environment type of the device 101 is “public space” and differs from the environment type of the group information of the belonging group ID “00001”, an explanation of this difference is displayed in the status details.

According to the present embodiment, in a case in which the settings of the device 101 that is a management target of the monitoring apparatus 102 are changed, by notifying the user of this, it is possible to easily recognize differences in the settings due to setting errors and the like. Thus, it is possible to avoid security risks in the installation environment of the device 101.

### OTHER EMBODIMENTS

In each of the above-described embodiments, rather than holding information indicating the environment type as group information, the monitoring apparatus 102 may determine the device registration information shown in FIG. 11 by referring to the settings of the device 101 already managed in the monitoring apparatus 102. For example, in a case in which the environment type of the two devices 101 with serial numbers “AAA00001” and “BBB00001” is “company intranet” as shown in FIG. 9, the monitoring apparatus 102 may specify “company intranet” as the environment type in the device registration information.

In each of the above-described embodiments, although the recommended setting value database 421 had a plurality of setting items of security functions, there may be as few as one setting item.

Embodiment(s) of the present invention can also be realized by a computer of a system or apparatus that reads and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-076840, filed May 8 2023, which is hereby incorporated by reference wherein in its entirety.

What is claimed is:

1. An information processing apparatus capable of being connected to a monitoring apparatus via a first network, configured for the purpose of transmitting operation information to a management server via a second network and the first network in accordance with monitoring by the monitoring apparatus, the information processing apparatus comprising:
a memory storing instructions; and
a processor executing the instructions causing the information processing apparatus to:
receive, from the monitoring apparatus, registration information for the management server that includes information indicating an environment type of the first network to which the information processing apparatus can be connected;
perform a security setting corresponding to the environment type, based on information indicating the environment type; and,
perform communication in order to initiate a connection to the management server based on the registration information.

2. The information processing apparatus according to claim 1, wherein the processor is configured to store recommended setting data that includes setting values of a plurality of security functions associated with the environment type, and perform the security settings based on the recommended setting data.

3. The information processing apparatus according to claim 2, wherein the recommended setting data includes information that indicates a plurality of environment types of different networks, and associates setting values of the plurality of security functions for each one of the environment types.

4. The information processing apparatus according to claim 3, wherein the processor is further configured to accept a change of the environment type by a user.

5. The information processing apparatus according to claim 4, wherein the processor is configured to restrict the change to at least one of the plurality of environment types.

6. The information processing apparatus according to claim 3, wherein the processor is further configured to accept a change of setting values of the plurality of security functions by a user.

7. The information processing apparatus according to claim 6, wherein the processor is configured to restrict the change of at least one of the setting values of the plurality of security functions.

8. The information processing apparatus according to claim 1, wherein the registration information further includes identification information that identifies the monitoring apparatus, and a registration code used in registration to the management server.

9. The information processing apparatus according to claim 1, wherein the information processing apparatus is an image forming apparatus provided with at least one function of a printer function and a scanner function, and
wherein the operation information includes data recorded based on the use of at least one of the functions.

10. An information processing method performed by an information processing apparatus capable of being connected to a monitoring apparatus via a first network, configured for the purpose of transmitting operation information to a management server via a second network and the first network in accordance with monitoring by the monitoring apparatus, the method comprising:
receiving, from the monitoring apparatus, registration information for the management server that includes information indicating an environment type of the first network to which the information processing apparatus can be connected;
setting a security setting corresponding to the environment type, based on information indicating the environment type; and,
performing communication in order to initiate a connection to the management server based on the registration information.

11. A non-transitory storage medium storing a computer program of an information processing apparatus capable of being connected to a monitoring apparatus via a first network, configured for the purpose of transmitting operation information to a management server via a second network and the first network in accordance with monitoring by the monitoring apparatus, causing a computer to perform each step of a processing method for the information processing apparatus, the processing method comprising:
receiving, from the monitoring apparatus, registration information for the management server that includes information indicating an environment type of the first network to which the information processing apparatus can be connected;
setting a security setting corresponding to the environment type, based on information indicating the environment type; and,
performing communication in order to initiate a connection to the management server based on the registration information.
